(19) United States
(12) Patent Application Publication
(10) Pub. No.: US 2008/0048502 A1
(43) Pub. Date: Feb. 28, 2008

(54) Current-Controlled Converter and Method for Controlling Said Converter

(75) Inventor: Hans-Georg Kopken, Erlangen (DE)

Correspondence Address: HENRY M FEIEREISEN, LLC, 350 FIFTH AVENUE, SUITE 4714, NEW YORK, NY, 10118, US

(73) Assignee: Siemens Aktiengesesellschaft, Munchen (DE)

(21) Appl. No.: 11/573,731

(22) PCT Filed: Aug. 10, 2005
(86) PCT No.: PCT/EP05/53925

§ 371 Date: Feb. 15, 2007

(30) Foreign Application Priority Data
Aug. 18, 2004 (DE) 10 2004 040 052.0

(51) Int. Cl. H02B 1/24; H02K 23/00

(52) U.S. Cl. 307/127; 318/437

(57) ABSTRACT

The invention relates to a current-controlled converter and a method for controlling a converter of this type (U) comprising three phase outputs (R, S, T). The method comprises the following steps: a) application of a test current signal (ip) to a first (R) and a second (S) phase output of the three phase outputs (R, S, T) and isolation of the third phase output (T), when the converter (U) is activated for operation; b) respective measuring of the test signal (ip) and generation of a measuring signal (imR, imS) that is proportional to the measured test signal (ip) for both the first (R) and the second (S) phase output; c) determination of a correction value (Δg1) that is dependent on said measuring signals (imR, imS); and d) control of the converter (U) in accordance with the determined correction value (Δg1). The inventive method is used in particular in a converter for controlling a three-phase motor (M).

The present invention relates to a current-controlled converter and to a method for controlling such a converter. In particular, the present invention relates to a method according to the preamble of claim 1, a current-controlled converter according to the preamble of claim 8 and to a corresponding use of such a converter according to the preamble of claim 10.

Current-controlled converters having a number of phase outputs, for example for operating three-phase motors, are generally known. Such a converter essentially has a control device and a current control device connected thereto which, in operation, control a switching device of the converter in such a manner that correspondingly switched phase currents are present at the three phase outputs.

To correct irregularities possibly occurring in the phase currents during the operation, and resultant torque fluctuations, the current control device has a feedback loop. For this purpose, current measuring devices such as, for example, current transformers, shunts or also optical current measuring sensors measure the currents present at the phase outputs and feed correspondingly generated measurement signals back to the current control device. In dependence on these measurement signals, the current control device, together with the control device, will control the switching device during the further operation in such a manner that the irregularities in the phase currents measured by the current measuring devices are balanced out. Thus, asymmetries between the individual phase currents and resultant fluctuations in the torque in the three-phase motor operated on these can be detected and correspondingly corrected.

As a rule, however, the current measuring devices themselves but also the components provided for the further processing of the measurement signals in the feedback loop such as, for example, operational amplifiers etc., have non-linearities and component tolerances which can influence the measurement result. In the case of a multi-channel measurement such as, for example, the three-phase measurement of the three phase currents at the converter, in particular, this leads to different measurement results in the individual phase currents. It is especially with identical phase currents that different measurement signals are thus generated for the individual phase outputs. Since these influence the current control, asymmetries can arise between the phase currents, now controlled with wrong measurement values, and thus also torque fluctuations in the further operation.

To prevent such asymmetries caused by tolerances and non-linearities, highly accurate current measuring sensors and operation amplifiers having lesser component tolerances and non-linearities can be used, for example. However, such selected components have the disadvantage that they are only available in small numbers and are thus expensive.

EP 1 345 312 describes a method for a multi-phase converter in which the asymmetries produced by component tolerances are compensated for. Before the initial start-up, for example during the production or after an exchange of the converter, two of the phase outputs of the converter are connected to one another via an external resistor for this purpose. In addition, the outputs of two current measuring devices provided at the phase outputs are connected to an external computing device. After that, the converter is switched in such a manner that a direct current flows between the two phase outputs connected to one another via the external resistor. Due to different component tolerances, however, this direct current which is present at both current measuring devices and is almost identical leads to different measurement signals at the outputs of the individual current measuring devices.

These different measurement signals are acquired by the external computing device, compared with one another and from these a correction value is determined. This correction value is then stored in a memory in the converter. During the operation of the converter with connected three-phase motor, this correction factor is correspondingly applied to one of the measurement signals via a multiplier and thus a compensation for the component tolerances is achieved.

However, this method known from EP 1 345 312 has the disadvantage that the determination of the asymmetries produced by component tolerances and their compensation in the converter is very expensive in terms of time and material. This is because, on the one hand, additional external devices such as resistor and computing device must be utilized for the determination. On the other hand, it is especially the changes in the components possibly occurring during the operation such as, for example, the changes in the gain factors caused by ageing effects or heat effects that cannot be recognized immediately. This is because a three-phase motor connected to the converter would have to be replaced time and again by the external resistor, the external computing device would have to be connected additionally, etc. in a time-consuming measuring procedure.

It is the object of the present invention, therefore, to provide a method and a corresponding converter which allow the asymmetries between the phase currents, caused by component tolerances and non-linearities, to be compensated for with less expenditure of time and material and as advantageously as possible.

This object is achieved by the method for controlling a current-controlled converter comprising three phase outputs, with the following steps:
a) applying a test current signal to a first and to a second phase output of the three phase outputs and isolating the third phase output when the converter is switched on for operation,
b) measuring the test current signal and generating a measurement signal proportional to the test current signal measured, in each case for the first and the second phase output,
c) determining a correction value depending on these measurement signals, and
d) controlling the converter in dependence on the correction value determined.

Furthermore, this object is achieved by the current-controlled converter having three phase outputs, a switching device for switching currents at the three phase outputs, a control device for controlling the switching device and a current control device connected to the control device, wherein the method according to the invention described previously is carried out on switch-on of the converter.

In particular, the asymmetries in the phase currents, caused by component tolerances and non-linearities in the components of the current measuring devices, can thus be detected and compensated for with a certain expenditure of time and material, i.e. without using additional external devices, by the method according to the invention and the converter constructed in accordance with the invention.

Furthermore, components without higher requirements for component tolerances can be used in the current measuring devices which allows converters to be constructed cost-effectively.

Due to the fact that the method according to the invention is carried out on switch-on of the converter and preferably with each restart of a three-phase motor connected to the converter, changes possibly occurring in the components of the current measuring devices can be recognized and compensated for as quickly as possible. Thus, for example, the changes in the gain factors of operational amplifiers, caused by ageing effects or heat effects, or also changes occurring dynamically due to magnetic coupling effects can be recognized and compensated for contemporaneously.

Since no additional external devices are necessary for determining the correction values, the method according to the invention can be carried out at any time with little time expenditure, but at least with every switch-on of the converter.

In a development of the method according to the invention, after the switch-on of the converter, steps a) to c) are carried out a first time for a first pair of the three phase outputs and a second time for a second pair of the three phase outputs, wherein
a first correction value is determined for the first pair of phase outputs at the first time, and
a second correction value is determined for the second pair of phase outputs at the second time, and wherein
the converter is controlled in dependence on the first and second correction value determined.

As a result, the asymmetries between the phase currents of the individual phase outputs, caused by component tolerances, can be determined and compensated for with minimized time expenditure, i.e. by repeating steps a) to c) only once even in the case of a converter with a three-phase current measurement, i.e. with three current measuring devices.

The correction values determined are preferably stored in means, preferably in corresponding means in the current control device of the converter, until the converter is switched off. Thus, the correction values determined once on switch-on with the aid of test current signals can be used for compensation in subsequent current-controlled operation of the converter.

If the test current signal is a short current pulse, particularly, for example, a current pulse having a pulse width of approx. 125 μs, unwanted movements of the rotor can be largely prevented when the three-phase motor is connected.

If steps a) to c) of the method according to the invention are carried out several times in succession after the switch-on of the converter, the sign of the test current signal changing with each new execution, rotor movements occurring in a connected three-phase motor can be minimized and thus further influences on the measurement can be reduced.

The current-controlled converter constructed according to the invention is preferably used for controlling a three-phase motor. As a result, the torque fluctuations in the three-phase motor, caused by component tolerances or non-linearities of the converter, can be compensated for.

In the further text, the invention and advantageous exemplary embodiments of the invention will be described in greater detail with reference to the following Figures, in which:

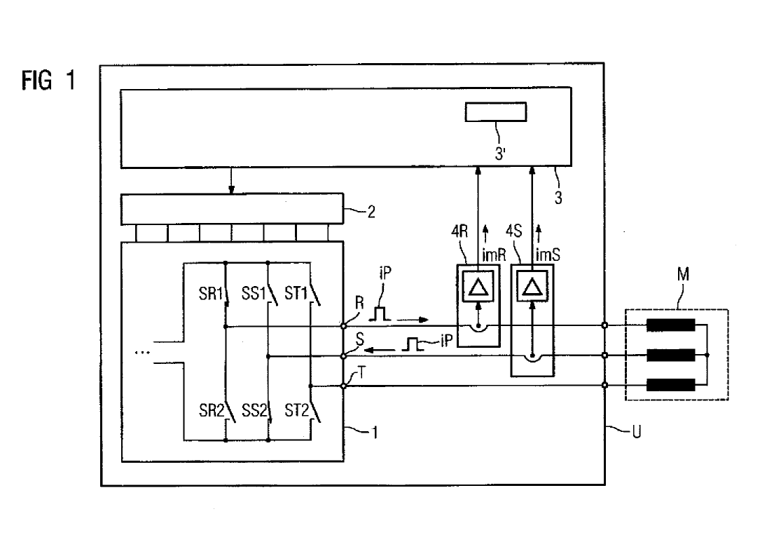

FIG. 1 shows a diagrammatic representation of an arrangement of three-phase motor and converter with two-channel current measurement,

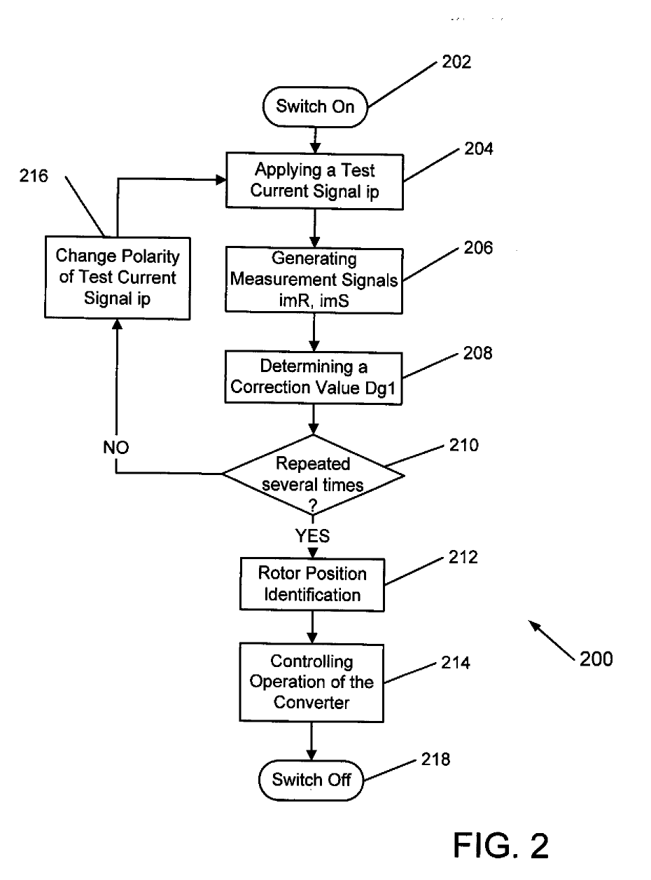

FIG. 2 shows a flowchart for restarting a three-phase motor with the aid of the method according to the invention,

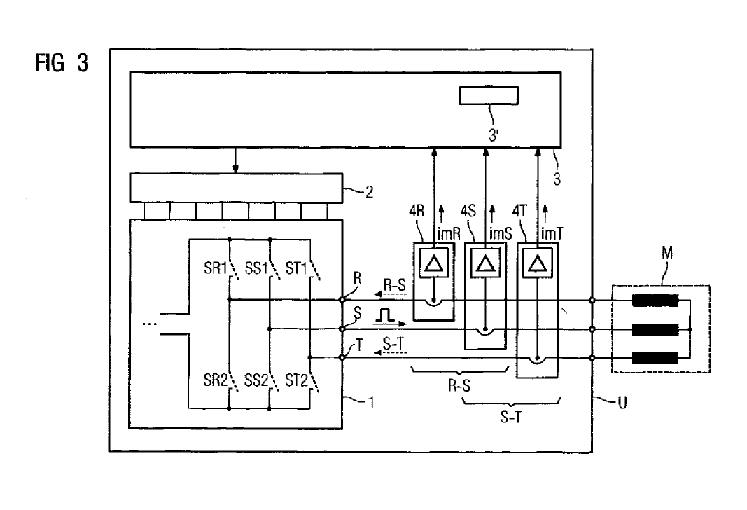

FIG. 3 shows a diagrammatic representation of the arrangement of three-phase motor and converter with three-channel current measurement.

Among other things, the converter U shown in FIG. 1 has a switching device 1, a control device 2, a current control device 3 and two current measuring devices 4R and 4S. The switching device 1 is shown here diagrammatically as a bridge circuit with six switches SR1, SR2, SS1, SS2, ST1 and ST2 for switching three phase outputs R, S and T. Since converters per se have long been known, a more detailed description of the switches and their operation in the converter will be omitted here. The current measuring devices 4R and 4S essentially in each case comprise a current measuring sensor installed in the phase line at one of the phase outputs R and S, with subsequent components such as, for example, operational amplifiers for amplifying the signals measured by the current measuring sensors. At the outputs of these components, corresponding measurement signals imR and imS will be present in dependence on the phase currents measured by means of the current measuring sensors. These measurement signals imR and imS are fed back to the current control device 3 and used by the latter, together with the control device 2, for the further control of the current-controlled converter U. Asymmetries of the sinusoidal phase currents at the three phase outputs R, S and T can thus be recognized in operation and correspondingly corrected.

As already described initially, component tolerances and non-linearities of the components current measuring devices 4R and 4S influence the feedback and can thus themselves cause asymmetries between the phase currents. These component tolerances and non-linearities manifest themselves, in particular, in the form of gain errors. According to the invention, a corresponding method and a corresponding converter is now proposed in which such gain errors, and resultant asymmetries, caused by components in the feedback branch can be compensated for especially with an unaltered configuration of the converter U, i.e. without further additional external components and devices.

Preferably, the method according to the invention is then used in a current-controlled converter U, shown in FIG. 1, for controlling a connected three-phase motor M.

The method according to the invention is preferably carried out directly on switch-on of the converter U and thus on a restart of the three-phase motor M. A subsequent rotor position identification can thus be carried out more reliably especially in a case of relatively small currents. The more symmetric the preceding current measurement was, the more accurate is thus the result of this rotor position identification since the rotor position must be determined via the differences in the phase currents from the rotor-position-dependent inductance.

The method according to the invention, which, of course, is essentially used for compensating for gain errors in the measurement signals can thus also easily be combined with an offset compensation to be carried out. This is because for reliable operation of the three-phase motor, it is absolutely necessary to compensate for all errors occurring in the current measuring devices, if possible.

In the text which follows, the principle of the method according to the invention will now be described in greater detail with reference to the flowchart shown in FIG. 2.

After the switch-on of the converter U, that is to say with a restart of the three-phase motor M, a test current signal ip is applied according to the invention to the two phase outputs R and S to which the current measuring devices 4R and 4S are connected, in a first step (step a)). At the same time, the third phase output T is isolated. As indicated in FIG. 1, the two phase outputs R and S can be connected by correspondingly switching the switches SR1 and SS2 and SR2 and SS1. The third phase output T is isolated by opening the two associated switches ST1 and ST2. This isolation of a phase output is also known by the term “pulse inhibitor” in the case of converters. The pulse inhibitor ensures that when the three phase motor M is connected without neutral conductor, the same test current signal ip with identical amplitude is impressed on the two phases R and S.

In the next step (step b)), the test current signals ip impressed on the phases R and S, measured by the current measuring sensors of the current measuring devices 4R and 4S, are converted into measurement signals imR and imS proportional to these signals.

Following this, a correction value Δg1 is determined in a further step (step c)) by means of the measurement signals imR and imS thus generated, which correction value is then used for controlling the converter U in actual operation. For this purpose, a ratio is preferably formed from the amplitudes of the two measurement signals imR and imS. Since, of course, the same test current pulse ip was the basis of the two measurement signals imR and imS, the factor Δg1, by means of which one of the two measurement signals must then be correspondingly corrected can be derived from this ratio.

Thus, for example, the following assumptions can be made:
imR [symbol] ip and
imS [symbol] (1+Δg1)ip

Since, of course, ip is identical at both phase outputs R and S, it can thus be assumed that the asymmetry between imR and imS resulting from the gain errors can be theoretically duplicated by the factor (1+Δg1).

This factor can be determined directly from the ratio of the two measurement signals imR and imS, namely:

$$\frac{imS}{imR} = \frac{( 1 + Δ g 1 ) \cdot ip}{ip} = 1 + Δ g 1.$$

A correction is then achieved by the correction value Δg1, in this case the correction value (1+Δg1), being applied to one of the measurement signals, in this case the measurement signal imS, when controlling the converter. More precisely, the measurement signal imS must be divided by (1+Δg1) in the present example and this corrected value imS/(1+Δg1), together with imR, must be used for the further controlling.

Once steps a) to c), which can be carried out several times in succession with a test current pulse ip with changing sign in each case, has been carried out, a rotor position identification can be performed subsequently as indicated in FIG. 2. When this has also been concluded, the converter U will change to the actual current-controlled operation of the connected three-phase motor. Thus, component tolerances and non-linearities of components in the individual measuring channels 4R and 4S of the feedback branch can be compensated for with the aid of the previously determined correction value Δg1 in this operating state.

This correction factor is preferably determined on switch-on of the converter before the rotor position identification and is stored until the drive is switched off. In a preferred embodiment, this correction value Δg1 determined is stored in the means 3′ of the current control device 3, shown in FIG. 1. As a result, ageing effects and other thermal effects, in particular, can also be taken into consideration during the determination of the rotor position.

A test current signal is preferably applied to the phase outputs by correspondingly switching the switches of the switching device 1, shown in FIG. 1, in time. Thus, a current pulse having a pulse duration of 125 μs can thus be generated at the corresponding phase outputs by correspondingly switching the switches in time. This form of current pulse is preferably selected in such a manner that it can also be used for the rotor position identification. As shown in FIG. 2, this is preferably carried out after the correction value Δg1 has been determined and before the converter is operated.

If, as shown in FIG. 3, the converter U has a three-phase current measurement with three current measuring devices 4R, 4S and 4T, the method according to the invention must be carried out at least twice. To compensate here, too, for the asymmetries caused by component tolerances and non-linearities in the three measuring channels, the aforementioned method steps a) to c) according to the invention are carried out, after the switch-on of the converter U, a first time for a first pair R-S of the three phase outputs R, S, T and a second time for, for example, a second pair S-T of the three phase outputs R, S, T. Correspondingly, the method steps could also be repeated with the pair R-T at the second time.

In this process, a first correction value Δg1 is determined for the first pair of phase outputs R-S at the first time and a second correction value Δg2 is determined for the second pair of phase outputs S-T at the second time. The first and second correction value Δg1, Δg2 determined is in each case again a factor which was determined from the ratios of the amplitudes of the respective measurement signals imR and imS of the first pair R-S and the ratio of the measurement signals imS and imT of the second pair S-T of phase outputs.

Apart from the three-phase current measuring device, the converter U shown in FIG. 3 corresponds to the converter U previously described with reference to FIG. 1. Accordingly, correction values Δg1 and Δg2 can also be determined in this way in this case by means of correspondingly generated and switched current pulses ip and stored in corresponding means 3′ until switch-off A multiple execution with changing sign of the current pulse will then lead to a minimization of the rotor movement of the connected three-phase motor, caused by the current pulses, particularly in this case.

Although the present invention has previously been described essentially only by means of a converter for controlling a three-phase motor, it should not be restricted to this one use. The method can be applied as well in the case of a converter for supplying a power supply system since in this case the asymmetries caused by component tolerances and non-linearities of components in the feedback branch would lead to deviations in the desired current variation in the power supply system.

1. A method for controlling a current-controlled converter with three phase outputs, said method being carried out with each restart of the converter and comprising the steps of:
a) applying a test current signal to a first phase output and to a second phase output of the three phase outputs and isolating a third phase output when the converter is switched on for operation,
b) measuring the test current signal and generating measurement signals, proportional to the measured test current signal, in each case for the first and the second phase outputs,
c) determining a correction value depending on these measurement signals, and
d) controlling the converter in dependence on the determined correction value.

2. The method as claimed in claim 1, wherein the determined correction value is a factor which is determined from a ratio of amplitudes of the measurement signals and wherein, in operation of the converter, the correction value is applied to one of the two measurement signals.

3. The method of claim 1, wherein after the converter is switched on, steps a) to c) are carried out a first time for a first pair of the three phase outputs and a second time for a second pair of the three phase outputs wherein
a first correction value is determined for the first pair of phase outputs at the first time, and
a second correction value is determined for the second pair of phase outputs at the second time, and wherein
the converter is controlled in dependence on the determined first and second correction values.

4. The method of claim 3, wherein the determined first correction value is a ratio of amplitudes of the measurement signals of the first pair, wherein the determined second correction value is a ratio of amplitudes of the measurement signals of the second pair of phase outputs, and wherein in operation of the converter, the first correction value is applied to the first pair of the measurement signals and the second correction value is applied to the second pair of the measurement signals.

5. The method of claim 3, wherein the determined first and second correction values are stored until the converter is switched off.

6. The method of claim 1, wherein the test current signal is a short current pulse having a duration to prevent an unwanted movement of the rotor.

7. The method of claim 1, wherein, after the converter is switched on, steps a)-c) are carried out repeatedly, and wherein the polarity of the test current signal is inverted each time the steps a)-c) are repeated.

8. A current-controlled converter with three phase outputs, comprising:
a switching device for switching currents at the three phase outputs, said switching device applying a test current signal to a first phase output and to a second phase output of the three phase outputs and isolating a third phase output when the converter is switched on for operation,
a control device for controlling the switching device, and
a current control device connected to the control device wherein the current control device measures the test current signal and generates measurement signals proportional to the measured test current signal, in each case for the first and the second phase outputs, determines a correction value depending on the measurement signals, and supplies the correction value to the control device for controlling characterized in that, the converter.

9. A current-controlled converter of claim 8, wherein the current control device has means for storing the determined correction value.

10. The current-controlled converter of claim 8 for use in the control of a three-phase motor.

11. The method of claim claims 1, wherein the test current signal has a pulse width of approximately 125 μs.
